(19) United States
(12) Patent Application Publication
(10) Pub. No.: US 2018/0082564 A1
(43) Pub. Date: Mar. 22, 2018

(54) WIRELESS ATTENDANCE MONITORING APPARATUS

(71) Applicants: Wei Fang, Langley (CA); Jing Yang, Richmond (CA)

(72) Inventors: Wei Fang, Langley (CA); Jing Yang, Richmond (CA)

(21) Appl. No.: 15/706,661

(22) Filed: Sep. 15, 2017

Related U.S. Application Data
(60) Provisional application No. 62/396,215, filed on Sep. 18, 2016.

(51) Int. Cl. G08B 21/04; H04Q 9/00

(52) U.S. Cl. CPC G08B 21/0469; H04Q 2209/40; H04Q 9/00; G08B 21/0484

(57) ABSTRACT

A remote monitoring and alerting system is provided for an appliance with knobs operation, such as an electrical or gas stove or range, to reduce the hazard caused by ignorance or forgetfulness during use of the appliance. The system includes one or more electrical knobs comprising a knob position sensor, a motion sensor; an alarm unit, and micro controller with timer function. A knob position sensor installed on a knob is connected to micro controller, the knob position sensor enabled for detection of appliance operation, the apparatus of the invention signals a person with an alarm when the person has not attended to the stove for a predetermined period of time. Users can be notified and interact with the connected apparatus through wireless network using mobile devices.

### PRIORITY CLAIMS

This application claims priority from U.S. provisional patent application Ser. No. 62/396,215, filed Sep. 18, 2016, the entire contents of which are incorporated herein by reference.

### FIELD OF TIE INVENTION

This present invention relates generally to monitoring and alerting solution for home appliances, and more particularly to an apparatus and a system for network-based, remote monitoring of appliances using rotary control knobs.

### BACKGROUND OF THE INVENTION

With today's busy life, people often work on multiple tasks at the same time and often get distracted while cooking or operating home appliances which are prone to safety hazards if left unattended. According to US national fire and protection association report 2013, unattended cooking causes nearly 90 percent of all kitchen fires in US. Various systems and solutions have been proposed or implemented to help reduce hazards.

Hoellerich, U.S. Pat. No. 6,294,994 describes an attendance monitoring apparatus is provided for an appliance, such as an electrical appliance, and includes a housing and a motion sensor assembly contained in the housing. A timer assembly is electrically connected to the motion sensor assembly, and an alarm assembly is electrically connected to the timer assembly. The timer assembly is adjustable for selecting a range of predetermined time intervals. Optionally, a current controller is electrically connected to the timer assembly. The current controller controls electric power to the appliance, such as an electric stove. The attendance monitoring apparatus of the invention signals a person with an audible alarm when the person has not attended to the electric stove for a predetermined period of time. Optionally, the attendance monitoring apparatus can turn off electrical power to the stove under these conditions. In this way, the attendance monitoring apparatus of the invention increases an operator's freedom and electric stove safety when the stove is in use. As a result, the attendance monitoring apparatus can prevent fires and save lives.

Klash, U.S. Pat. No. 7,002,109 describes a burner sensor is electrically interconnected with a control circuit, the burner sensor enabled for detection of burner operation, the control circuit providing a timing feature enabled, during burner operation, for continuous repetitive timing cycles each for a fixed selected time interval and for activating at least one of an audio, i.e., buzzer, and a visual alarm for a fixed duration, at the completion of each of the timing cycles. Thus, the operator is alerted to the fact that a heating coil is hot so that a significant burn and fire hazard is avoided.

Common solutions for reducing hazards often require professional installation as it involves changes in the wiring of the home appliances. Also, there does not exist a universal solution that would suit all appliances, for example, solutions applied to electrical stoves could not be used directly on gas stoves. Besides, with the development of internet of things and mobile technology, people always want to get more closely connected with family members and to learn what is happening at home at any time anywhere. However, existing related arts mentioned above lack the ability to communicate real-time operative status of home appliance to other remote users.

### SUMMARY OF THE INVENTION

It is therefore an object of the present invention to provide an improved appliance attendance and usage monitoring apparatus that signals a person to be attentive to an appliance without modifying the wiring or fuel source of the appliance. Electrical knobs of the present invention are used to replace existing knobs on the appliance and sends knob position change information indicating operational status of the appliance to a backend server through a service gateway. The attendance monitoring apparatus of the present invention signals a person with an audible alarm and or a visual alarm, when the person has not attended to the appliance for a predetermined period of time.

It is another object of the present invention to provide remote monitoring features, such as push notification to remote devices. Users gets notification on their mobile device when the knob is turned on or off. Users can also check the status of the appliance remotely at any time with internet access. Notification could be short text message, push notification to mobile devices or emails sent to user predefined email accounts. This provides access for other family members or caregivers to remotely monitor operative status and usage of the appliance.

It is a further object of the present invention to record and store appliance usage data and alerts history on the backend server and made such information accessible by authorized users. Such data could also be used for further activity analysis and incident analysis.

It is another object of the present invention to provide a multi-users remote monitoring system which enables a user to access the information of an electrical appliance, as well as allowing other users with granted access to receive notification and access the information remotely, thereby enabling family members or guardians to assist in monitoring appliance and its usage. Optionally, a control unit could be added to the system to control the electric current in order to remotely shut off the power supply to the appliance, or to receive signals from a server to shut off the power supply of the appliance under predetermined conditions.

These and other objects are provided, according to the present invention, by a home appliance safety and usage monitoring system used on any home appliance with knobs operation which comprises electrical knob with knob position sensor, a service gateway interconnected wirelessly with motion sensor and audible alert, cloud based server and an application running on mobile device or PC. Optionally, the electrical knob comprises an actuator, such as a current control box or smart switch, to control the electrical power supply to the appliance. Users replace the regular knobs on the appliance with the electrical knobs from this present invention, plug in the service gateway to the power outlet and connect to network. Mobile device apps can be downloaded from the app store or pushed down to the devices for user to receive notification and use of the app.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an electrical knob constructed in accordance with one embodiment of the invention;

FIG. 2 is a block diagram of a service gateway constructed in accordance with one embodiment of the invention;

FIG. 3 are block diagrams of a system constructed in accordance with one embodiment of the invention;

FIG. 4 is a flowchart illustrating the top-level functional operation of a system constructed in accordance with one embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It shall be understood that the accompanying drawings are presented solely to elucidate the following detailed description, are therefore, exemplary in nature and do not include all the possible permutations of the present invention.

### DETAILED DESCRIPTION

In order to make the purpose of the utility model, technical solutions and advantages more apparent below in conjunction with the accompanying drawings and embodiments described in further details for a network-based remote monitoring and alerting solution for home appliance. It shall be understood that the drawings are for purposes of illustration only and not by way of limitation of the invention.

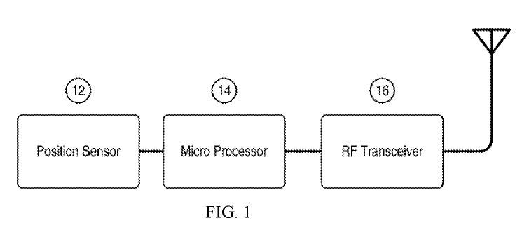

FIG. 1 shows one embodiment of an electrical knob of the present invention. This electrical knob is to replace an existing knob on a home appliance, for example, a cooking range. Micro-Processor 14 inside electrical knob 10 reads from knob position sensor 12 information indicative of a change of an operative status of the appliance.

In one embodiment, electrical knob 10 is a vertically mounted knob that includes an accelerometer or a magnetoresistive angle sensor to serve as knob position sensor 12. In another embodiment, electrical knob 10 is a horizontally mounted knob, in which case, may include a magnetoresistive angle sensor as knob position sensor 12. When a magnetoresistive angle sensor is used, a magnet ring is installed on the stove surface underneath the knob. Earth gravity field and magnetic field detected by knob position sensor 12 carries information on properties such as direction, presence, rotation, angle or electrical currents. Such information is used by the service gateway 20 to determine rotation angle change information of the electrical knob, which in turn is indicative of a change in the operative status of the appliance. This present invention determines rotation angle change information by making calculation based upon the detected earth gravity field, or the detected magnetic field, or combination thereof.

In another embodiment, electrical knob 10 comprises a battery unit which provides power to Knob position sensor 12 and RF transceiver 16. In order to support longer standby time of 6 months or more, an ultra-low power wireless protocol is adopted for wireless communication between the electrical knob and the service gateway.

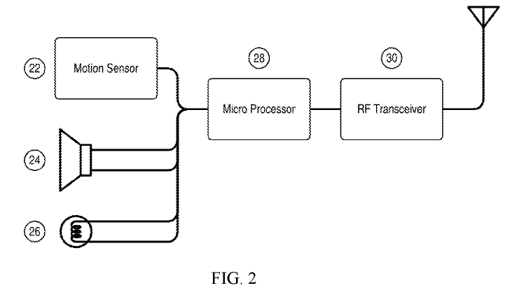

FIG. 2 illustrates service gateway 20 which is used to transmit and receive data from electrical knob 10, service gateway 20 interconnects with a motion sensor receiver 22 and an audible alarm 24 and/or a visual alarm 26. The audible alarm 24 could be hosted together with service gateway 20 or separately.

In a preferred embodiment, when a user operates the appliance using the electrical knob 10, microprocessor 12 sends information detected by knob position sensor 12 using RF Transceiver 16 to service gateway 20 via short range wireless protocols 40, including but not limited to, Bluetooth, Z-Wave or ZigBee. Service gateway 20 uses the received information detected by knob position sensor 12 to determine rotation angle change information which is indicative of an operative status of the appliance under monitor. Motion sensor receiver 22 is wirelessly connected to an external motion sensor unit. Motion sensor receiver 22 then receives information about human presence in proximity of the monitored appliance detected by the external motion sensor. Service gateway 20 activates audible alarm 24 or visual alarm 26 or both when the determined operative status indicates that the electrical device is in operation and said second sensor detects no human presence in proximity for a predetermined period of time.

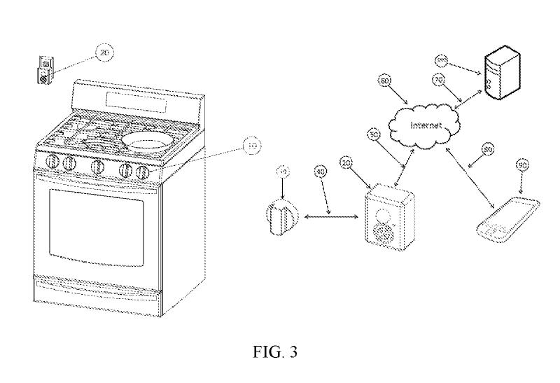

FIG. 3 shows an example of remote monitoring system using the electrical knob of the present invention. The system comprises one or more electrical knob 10, a service gateway 20, a backend server 100, one or more motion sensor 110, and mobile device app 90.

Motion sensor 110 detects human presence in the proximity of the appliance under monitor.

In a preferred embodiment, when a user operates the appliance using the electrical knob 10, microprocessor 12 sends information detected by knob position sensor 12 using RF Transceiver 16 to service gateway 20 via short range wireless protocols 40, including but not limited to, Bluetooth, Z-Wave or ZigBee. Service gateway 20 uses the received information detected by knob position sensor 12 to determine rotation angle change information which is indicative of an operative status of the appliance under monitor. service gateway 20 also receives information from motion sensor 110. Service gateway 20 activates an alarm unit when said operative status indicates that the electrical device is in operation and said second sensor detects no human presence in proximity for a predetermined period of time.

In an alternate embodiment, service gateway 20 is further connected to backend server 100 using the internet through an integrated router, or via home router using Wi-Fi, power line or other home network 50. Rotation angle change information detected in electrical knob 10 and human presence information detected by motion sensor 110 are sent to backend server 100 through service gateway 20. Backend server 100 then processes the received data, analyzes the collation, stores appliance usage, incident records and trends, and makes such data records accessible by authorized users. Two main purpose of those data: 1) usage data per appliance for energy consumption analysis. 2) attendance and alerts data for behavior analysis. By collating with other behavior data, it could provide early alert for potential memory drop.

Backend server 100 could be hosted in a cloud, in home network or a private network.

Mobile device 90 could be a smart phone, a tablet, or other mobile devices. Users can download a mobile device application and receives notification sent to such mobile application when the system detects a change in the operative status of the appliance under monitor, as well as receives a separate notification when the detected operative status indicates that the electrical device is in operation but there is no human presence in proximity of the appliance under monitor for a predetermined period of time. The mobile application also enables a user to configure system parameter settings, including but not limited to, the desired time period to monitor before activating an alarm, whether to activate a visual alarm or an audible alarm or both, as well as whether to take into account human presence information. In a further embodiment, the monitoring system of the present invention supports access and control by multiple users. Thus, the system does not only enable the user operating the appliance to receive and access the information of an electrical appliance, but also allows other users with granted access to receive notification and access information remotely, thereby enabling family members or guardians to assist in monitoring operative status of an appliance and its usage.

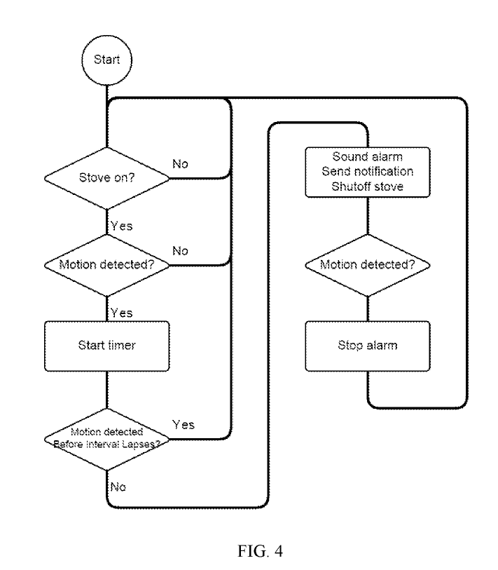

Having described the electrical knob, the service gateway and the system of the present invention, reference is now made to FIG. 4, which is a flowchart that depicts top-level functional operation of a system constructed in accordance with one embodiment of the invention. In this regard, using a cooking stove as an example, when a user turns on the stove by turning the knob of the stove from “off” to “on” position, a knob position sensor in the electrical knob detects information indicative of a change in the operative status of the stove. Simultaneously, a motion sensor in the system starts tracking of human presence in the proximity of the stove. When it is detected that there is no human presence, it is clear that the stove in operation is unattended. A timer unit will start. When the timer reaches a predetermined time period, e.g. 5 minutes, and there is still no sign of human presence, the system will trigger local audible or visual alarm to alert the user. As a further enhancement, the system also sends notification to mobile device applications of authorized users registered for remote monitoring. Further, the system may also terminate power supply to the stove. This can be achieved by activating an actuator built into the electrical knob to mechanically change the electrical knob from “on” to “off” position. After the local alarm is activated, the system continues to monitor human presence in proximity and automatically deactivates the alarm when human presence is once again detected, which indicates that the stove is once again attended by a user.

Indeed, the foregoing description has been presented for purposes of illustration and description. It is not intended to be exhaustive or to limit the invention to the precise forms disclosed. Obvious modifications or variations are possible in light of the above teachings. For example, a cooking appliance has been used as an example of a home appliance of the present invention. However, it will be appreciated that the present invention may apply to any home appliance with rotary knob operation.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. An electrical knob of a device comprising:
a microprocessor;
a sensor configured to detect information indicative of change in an operative status of said device;
a wireless communication module configured to wirelessly transmit and receive data to and from a remote unit;
wherein said microprocessor reads information indicative of change in the operative status from said sensor and transmits said operative status to a remote unit using said wireless communication module;

2. An electrical knob of claim 1, further comprising a battery unit configured to provide power for said sensor unit and said wireless communication module;

3. An electrical knob of claim 1, wherein the sensor is an accelerometer configured to detect change in earth gravity field.

4. An electrical knob of claim 1, wherein the sensor is a magnetoresistance sensor configured to detect change in magnetic field.

5. An electrical knob of claim 1, wherein said wireless communication module uses a short range wireless protocol.

6. The electrical knob according to claim 1, further comprising an actuator, wherein said electrical knob is electrically interfaced with an actuator and said microprocessor is configured to change the rotational position of the knob using said actuator.

7. The electrical knob according to claim 1, further comprising a second sensor configured to detect vibration motion of the knob when operated by a user and said electrical knob is further configured to activate said wireless communication module upon detection of said vibration motion.

8. A system for providing safety and usage monitoring of a home appliance with knob operation, said system comprising:
an electrical knob comprising a wireless communication module and is electrically interfaced with a first sensor, wherein said first sensor is configured to detect operative status of said home appliance, and said wireless communication module is further configured to wirelessly transmit said operative status to a service gateway;
a service gateway configured to wirelessly receive information in connection with said operative status;
a second sensor configured to detect human presence in proximity to said home appliance; and
an alarm unit;
wherein said alarm unit is activated when said operative status indicates that the home appliance is in operation and said second sensor detects no human presence in proximity for a predetermined period of time.

9. The system according to claim 8, wherein said second sensor is a motion sensor.

10. The system according to claim 8, wherein said alarm unit is an audible alarm.

11. The system according to claim 8, wherein said alarm unit is a visual alarm.

12. The system according to claim 8, further comprising a server, wherein said service gateway is further configured to transmit said information indicative of said operative status and information detected on human presence in proximity to said server.

13. The system according to claim 12, wherein said electrical knob is electrically interfaced with an actuator, and said server sends a control signal to activate said actuator.

14. The system according to claim 12, further comprising a mobile application wherein said server sends notification to said mobile application when said first sensor detects a change in said operative status of said home appliance.

15. The system according to claim 12, further comprising a mobile application wherein said server sends notification to said mobile application when said operative status indicates that said home appliance is in operation and said second sensor detects no human presence in proximity for a predetermined period of time.

16. The system according to claim 12, wherein said server processes and stores said operative status.

17. A method providing safety and usage monitoring of a home appliance with an electrical knob, comprising the steps of:
detecting change in operative status of said home appliance;
detecting human presence in proximity to said home appliance;
activating an alarm unit when said operative status indicates that the home appliance is in operation and there is no human presence in proximity for a predetermined period of time;
wirelessly transmitting information related to said operative status and human presence in proximity to a remote unit; and
sending notification to a mobile application when said operative status indicates that the home appliance is in operation and there is no human presence in proximity for a predetermined period of time.

18. The method according to claim 17, further comprising the step of changing rotational position of said electrical knob using an actuator electrically interfaced with the knob.

19. The method according to claim 17, further comprising the steps of deactivating said alarm unit when human presence is detected after said alarm unit is activated.
